(19) United States
(12) Patent Application Publication
(10) Pub. No.: US 2008/0012187 A1
(43) Pub. Date: Jan. 17, 2008

(54) Gas spring with pressure switch to identify loss of charge

(76) Inventors: Walter Douglas Bauman, Wixom, MI (US); Mark M. Rose, Myrtle Beach, SC (US); Todd Alan Greve, Myrtle Beach, SC (US); Robert Joseph Burnstingle, Marion, SC (US); Kenneth Delano Gerald, Mullins, SC (US); Richard E. Bluemle, Columbia, SC (US)

Correspondence Address: CARLSON, GASKEY & OLDS, P.C., 400 WEST MAPLE ROAD, SUITE 350, BIRMINGHAM, MI, 48009, US

(21) Appl. No.: 11/484,500

(22) Filed: Jul. 11, 2006

(51) Int. Cl. F16F 5/00

(52) U.S. Cl. 267/64.11

(57) ABSTRACT

A gas spring that has particular advantage in a vehicle safety system which is infrequently used, includes a safety switch to monitor pressure of compressed gas within a cylinder. Should the pressure in the cylinder drop below a predetermined minimum, a switch component moves to break an electric circuit. A control can then determine that the pressure is insufficient and a warning can be actuated.

### BACKGROUND OF THE INVENTION

This application relates to a gas spring, such as generally utilized in vehicle applications wherein a piston is connected to one of two relatively movable members, and a cylinder is connected to the other. A charge of compressed gas is received within the cylinder, and assists in moving and cushioning the piston as it moves relative to the cylinder. A pressure switch is incorporated into the gas spring to identify a loss of pressure within the cylinder, such that some warning can be given.

Gas springs are utilized in many vehicle applications. In one common application, gas springs are connected between a movable closure such as a trunk or lift gate, and a vehicle frame. The gas spring typically includes a piston connected to one of the two components, and received within a cylinder. The cylinder is connected to the other of the two components. A charge of compressed gas is received within the cylinder, and assists in driving the piston outwardly when the two vehicle components move relative to each other. When the two components move toward each other, the compressed gas will cushion the movement.

Many applications for gas springs receive repeated usage. Thus, should a gas spring be failing in an application such as a lift gate, a user of the vehicle will soon be made aware of the failure.

However, gas springs are now being proposed for applications which would have much more infrequent use. As one proposed application, gas springs are utilized to drive a safety device in a vehicle. In one proposed application, gas springs would be selectively actuated to drive a vehicle hood to pivot upwardly from a rear end of the hood, when a crash sensor identifies a pedestrian having been contacted by the forward end of the vehicle. In the past, a pedestrian contacted by a forward end of a vehicle may be thrown forwardly into the vehicle, and against the windshield. With the proposed safety device, a crash sensor actuates the hood to pivot upwardly, and such that the hood cushions the pedestrian's contact with the vehicle.

In this application, the gas springs are utilized to drive the hood. The gas springs may not be actuated for years. However, when a pedestrian accident does occur, the gas spring must be operable to provide sufficient strength to drive the hood. Thus, if there is a loss of pressure charge within the gas spring, it would be undesirable.

### SUMMARY OF THE INVENTION

In a disclosed embodiment of this invention, a pressure switch is associated with a gas spring. The pressure switch is operable to monitor a pressure in a charged chamber in a cylinder. Should that pressure drop below a predetermined value, a warning is sent to an operator of the vehicle.

In a disclosed embodiment, the pressure switch is a pin that extends downwardly into the cylinder. Pressurized gas within the cylinder forces this pin outwardly of the cylinder. A spring in a pressure switch housing biases the pin into the cylinder. With the pin forced into the pressure switch housing, a circuit contact is maintained. However, should the spring overcome the force of the pressure within the cylinder, the pin will move away, causing an open circuit. At that point, a control can determine that the gas spring has a low charge, and a warning can be actuated.

These and other features of the present invention can be best understood from the following specification and drawings, the following of which is a brief description.

### BRIEF DESCRIPTION OF THE DRAWINGS

FIG. 1 is a highly schematic view of a safety device incorporating the inventive gas spring.

FIG. 2A shows the gas spring having a pressure switch in a normal position.

FIG. 2B shows the position of the components of the pressure switch when the pressure within the gas spring has fallen.

FIG. 3 schematically shows further details of the inventive pressure switch.

### DETAILED DESCRIPTION OF THE PREFERRED EMBODIMENT

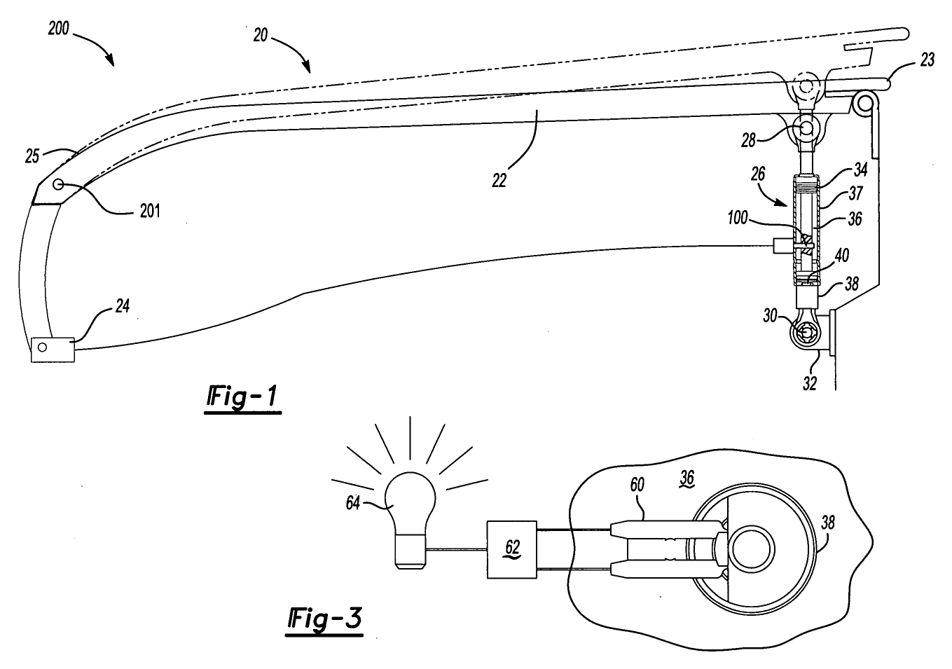

A safety system 20 is illustrated in FIG. 1. A hood 22 of a vehicle includes a forward end 25 and a rear end 23. The hood 22 typically pivots from the rear end 23 such that the forward end 25 provides access to an engine compartment. In a feature of this invention, a crash sensor 24 is positioned near the forward end 25 of the vehicle. If the crash sensor 24 determines that the vehicle has contacted a pedestrian, then a gas spring 26 (or several gas springs) are actuated to drive a piston 34 to move outwardly against a connection 28 to the hood 22. This causes the hood 22 to pivot about the forward end 25 such that the rear end 23 raises to cushion impact of the pedestrian.

In one example, a solenoid controlled pin 100 holds piston 34 at a compressed position. Pin 100 is released when a front pedestrian impact is detected by sensor 24. This drives the hood 22 to the position shown in phantom at 200.

Typically, the hood 22 would be able to move during normal operation to provide access to the engine compartment without any movement of the portion driven by the gas spring 26. The connection of all of these components may be as known, and forms no portion of this invention.

Another end 30 of the gas spring 26 is connected to a vehicle frame at 32. The piston 34 is movable within a housing providing a cylinder 37. A chamber 36 within the cylinder 37 is provided with a charge of compressed gas. A pressure switch 38 has a pin 40 extending into the chamber 36.

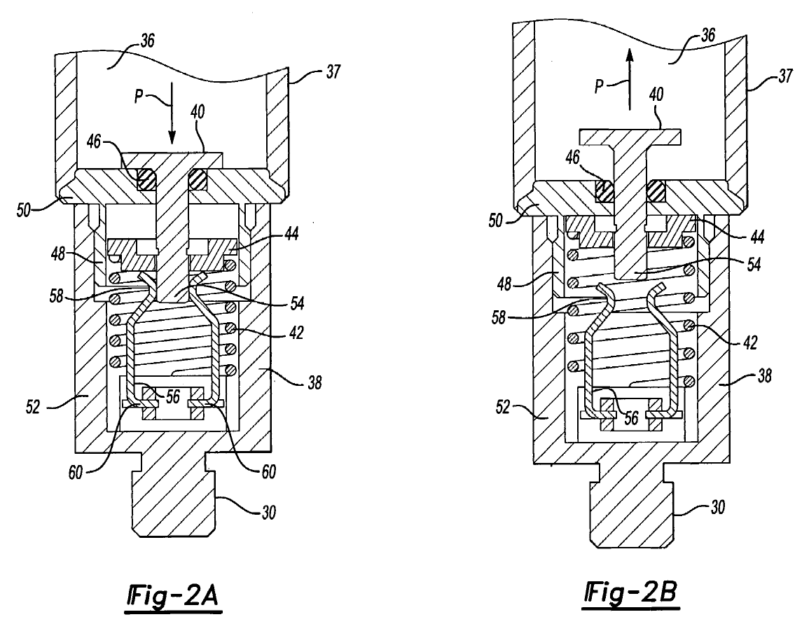

As shown in FIG. 2A, the pin 40 is biased out of the chamber 36 by a pressure P in the chamber 36. In opposition, a spring 42 forces a cap 44, movable with the pin 40, back into the chamber 36. The spring 42 is sized such that if the chamber 36 is properly charged, the pin 40 will be held in the position illustrated in FIG. 2A.

A seal 46 seals the chamber 36 at an opening through which the pin 40 moves. A guide 48 guides the movement of the cap 44. An end 50 of a housing 52 for the pressure switch 38 is connected to the cylinder 37.

A lower end 54 of the pin 40 is received between fingers 58. The pin 40, at least at its end 54, and the fingers 58, are electrically conductive. Thus, as long as the pin 40 remains in the FIG. 2A position, a circuit is created between the two fingers 58 which are connected by the end 54. Fingers 58 connect to members 56 which in turn are connected to terminals 60.

As shown in FIG. 3, terminals 60 extend to an electrical power and control 62. As known, a small voltage can be sent through this circuit, and control 62 can monitor that the circuit is maintained. A warning, such as an audible signal, or some form of warning light 64 can be placed on a dash of a vehicle.

As shown in FIG. 2B, should the pressure within the chamber 36 fall, then the pin 40 can move under the influence of the spring 42, and the circuit between the lower end 54 and the fingers 58 is broken. At that point, the warning light 64 can be actuated.

The present invention thus provides a relatively simple way of monitoring the continued operability of a gas spring.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle safety system comprising:
a movable vehicle member in a position to be movable from a normal position to a safety position, said movable vehicle member cushioning an impact in said safety position;
at least one gas spring for driving said movable vehicle member to said safety position, said at least one gas spring including a piston attached to one of said movable vehicle member and a second vehicle component, and a cylinder receiving said piston, said cylinder being attached to the other of said movable vehicle member and said second vehicle component, and a pressurized gas chamber formed within said cylinder, and operable to drive said piston outwardly of said cylinder; and
a switch for monitoring pressure in said pressurized gas chamber, and moving to actuate a warning device should said pressure drop below a predetermined minimum.

2. The vehicle safety system as set forth in claim 1, wherein said switch includes a pin extending into said pressurized gas chamber, and driven outwardly of said pressurized gas chamber by said pressure.

3. The vehicle safety system as set forth in claim 2, wherein a spring drives said pin into said pressurized gas chamber.

4. The vehicle safety system as set forth in claim 2, wherein said pin includes an electrically conductive portion received to complete a circuit in either a normal position or an actuated position.

5. The vehicle safety system as set forth in claim 4, wherein said pin is received between two electrically conductive components to complete the circuit when the pressure within said pressurized gas chamber is above said predetermined minimum.

6. The vehicle safety system as set forth in claim 1, wherein said piston is maintained in a collapsed position in said cylinder by a holding member.

7. The vehicle safety system as set forth in claim 6, wherein a crash sensor actuates said holding member to release said piston.

8. A gas spring comprising:
a piston to be attached to one of a movable vehicle member and a second vehicle component, and a cylinder receiving said piston, said cylinder to be attached to the other of the movable vehicle member and the second vehicle component, and a pressurized gas chamber formed within said cylinder, and operable to drive said piston outwardly of said cylinder; and
a switch for monitoring pressure in said pressurized gas chamber, and moving to actuate a warning device should said pressure drop below a predetermined minimum.

9. The gas spring as set forth in claim 8, wherein said switch includes a pin extending into said pressurized gas chamber, and driven outwardly of said pressurized gas chamber by said pressure.

10. The gas spring as set forth in claim 9, wherein a spring drives said pin into said pressurized gas chamber.

11. The gas spring as set forth in claim 9, wherein said pin includes an electrically conductive portion received to complete a circuit in either a normal position or an actuated position.

12. The gas spring as set forth in claim 11, wherein said pin is received between two electrically conductive components to complete the circuit when the pressure within said pressurized gas chamber is above said predetermined minimum.

13. The gas spring as set forth in claim 8, wherein said piston is maintained in a collapsed position in said cylinder by a holding member.

14. The gas spring as set forth in claim 13, wherein a crash sensor actuates said holding member to release said piston.
